(19) United States
(12) Patent Application Publication
(10) Pub. No.: US 2023/0129398 A1
(43) Pub. Date: Apr. 27, 2023

(54) Fish Tape Drilling Attachment Device

(71) Applicant: Douglas Dickie, Prescott, AZ (US)

(72) Inventor: Douglas Dickie, Prescott, AZ (US)

(21) Appl. No.: 18/046,549

(22) Filed: Oct. 14, 2022

Related U.S. Application Data
(60) Provisional application No. 63/271,373, filed on Oct. 25, 2021.

(51) Int. Cl. H02G 1/08

(52) U.S. Cl. CPC H02G 1/085; H02G 1/083; B23B 45/003

(57) ABSTRACT

The present invention relates to a fish tape drilling attachment device primarily comprised of a housing, further comprised of at least one bearing, at least one shaft, at least one cam, and at least one cam lever. A fish tape can be fed through the housing such that it is contacted by the cam, wherein the shaft can spin freely within the housing via the bearing such that the hammer action of the drill causes the fish tape to act like a spring in order to slowly move the fish tape through a piece of conduit.

### CROSS-REFERENCE TO RELATED APPLICATION

The present application claims priority to, and the benefit of, U.S. Provisional Application No. 63/271,373, which was filed on Oct. 25, 2021, and is incorporated herein by reference in its entirety.

### FIELD OF THE INVENTION

The present invention relates generally to the field of electrical wire feeding. More specifically, the present invention relates to a fish tape drilling attachment device primarily comprised of a housing, further comprised of at least one bearing, at least one shaft, at least one cam, and at least one cam lever. A fish tape can be fed through the housing such that it is contacted by the cam, wherein the shaft can spin freely within the housing via the bearing such that the hammer action of the drill causes the fish tape to act like a spring to slowly move the fish tape through a piece of conduit. Accordingly, the present disclosure makes specific reference thereto. Nonetheless, it is to be appreciated that aspects of the present invention are also equally applicable to other like applications, devices, and methods of manufacture.

### BACKGROUND

A fish tape is a thin piece of steel wire in a flat style that is coiled at a predetermined length. To be able to pull a wire through a pipe/conduit, you must first run the fish tape through the pipe. When pushing a fish tape into a conduit, friction is created. To overcome this friction, electricians typically pinch the fish tape with a pair of pliers and rapidly push the tape into the conduit in bursts. This movement makes the tape act like a spring to slowly move the tape through the conduit. However, this method is extremely inefficient, time-consuming, and physically exhausting. In addition, fish tape often gets stuck at the ends of long conduits. Extra manpower is usually needed to pull apart conduits at the end of runs to help feed the fish tape through as well. Hazards may also occur when technicians climb up into rafters to pull apart electrical wiring systems. All these extra steps and roadblocks result in increased costs and decreased productivity for electrical companies.

Therefore, there exists a long-felt need in the art for a device that aids an electrician in running fish tape more efficiently. There also exists a long-felt need in the art for a fish tape drilling attachment device that eliminates the need to use lineman pliers and the need to pull apart conduits. Further, there exists a long-felt need in the art for a fish tape drilling attachment device that can be universally used with any drill.

The subject matter disclosed and claimed herein, in one embodiment thereof, comprises a fish tape drilling attachment device. The device is primarily comprised of a housing further comprised of at least one bearing, at least one shaft, at least one cam, and at least one cam lever. A fish tape can be fed through the housing such that it is contacted by the cam. The shaft can spin freely within the housing via the bearing such that the hammer action of the drill causes the fish tape to act like a spring to slowly move the fish tape through a piece of conduit.

In this manner, the fish tape drilling attachment device of the present invention accomplishes all of the foregoing objectives and provides a more efficient method of running fish tape. In doing so, the device eliminates the need to use lineman pliers and the need to pull apart conduits. Further, the device can be universally used with any drill making it extremely versatile.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fish tape drilling attachment device. The device is primarily comprised of a housing, further comprised of at least one bearing, at least one shaft, at least one cam, and at least one cam lever. The housing is preferably generally cylindrical in shape and is comprised of a front wall, a side wall, and a rear wall. The rear wall is comprised of at least one opening that allows at least one shaft to reside within an interior space of the housing. A first end of the shaft is preferably a standard quick-connect shaft that allows the device to be attached to any power drill known in the art. At least one first bearing attaches to or contacts the second end near the rear wall within the interior space which ensures alignment of the shaft within the opening and interior space during use. At least one second bearing attaches to or contacts the second end near the front wall within the interior space that allows load from the shaft to be applied and rotation to continue.

The housing is further comprised of at least one cam located within the housing, wherein the position of the cam within the housing can be adjusted via at least one cam lever. Fish tape can be fed through an opening of the housing that extends from the front wall to the rear wall such that the cam contacts the fish tape within the housing.

After the shaft is attached to a drill via the drill chuck, rotation of the chuck will cause the shaft to spin. The bearings allow the shaft to spin freely within the interior space such that the hammer action of the drill causes the fish tape to act like a spring to slowly move the fish tape through a piece of conduit.

Accordingly, the fish tape drilling attachment device of the present invention is particularly advantageous as it provides a more efficient method of running fish tape. The device eliminates the need to use lineman pliers and the need to pull apart conduits and can be universally used with any drill, making it extremely versatile. In this manner, the fish tape drilling attachment device overcomes the limitations of existing methods of using fish tape known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a fish tape drilling attachment device of the present invention wherein the housing is shown in a cross-sectional view and the device is being used to direct a fish tape through a conduit in accordance with the disclosed architecture; and

FIG. 2 illustrates a side cross-sectional view of one potential embodiment of a fish tape drilling attachment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that aids an electrician in running fish tape more efficiently. There also exists a long-felt need in the art for a fish tape drilling attachment device that eliminates the need to use lineman pliers and the need to pull apart conduits. Further, there exists a long-felt need in the art for a fish tape drilling attachment device that can be universally used with any drill.

The present invention, in one exemplary embodiment, is comprised of a fish tape drilling attachment device primarily comprised of a housing, further comprised of at least one bearing, at least one shaft, and at least one cam lever. The housing is preferably generally cylindrical in shape and is comprised of a front wall, a side wall, and a rear wall. The rear wall is comprised of at least one opening that allows at least one shaft to reside within an interior space of the housing. Further, a first end of the shaft is preferably a standard quick-connect shaft that allows the device to be attached to any power drill known in the art. At least one first bearing attaches to or contacts the second end near the rear wall within the interior space. This ensures alignment of the shaft within the opening and interior space during use. At least one second bearing attaches to or contacts the second end near the front wall within the interior space that allows load from the shaft to be applied and rotation to continue.

The housing is further comprised of at least one cam. The cam is located within the housing, wherein the position of the cam within the housing can be adjusted via at least one cam lever. Fish tape can be fed through an opening of the housing that extends from the front wall to the rear wall such that the cam contacts the fish tape within the housing.

After the shaft is attached to a drill via the drill chuck, rotation of the chuck will cause the shaft to spin. The bearings allow the shaft to spin freely within the interior space such that the hammer action of the drill causes the fish tape to act like a spring to slowly move the fish tape through a piece of conduit.

Accordingly, the fish tape drilling attachment device of the present invention is particularly advantageous as it provides a more efficient method of running fish tape. The device eliminates the need to use lineman pliers and the need to pull apart conduits and can be universally used with any drill, making it extremely versatile. In this manner, the fish tape drilling attachment device overcomes the limitations of existing methods of using fish tape known in the art.

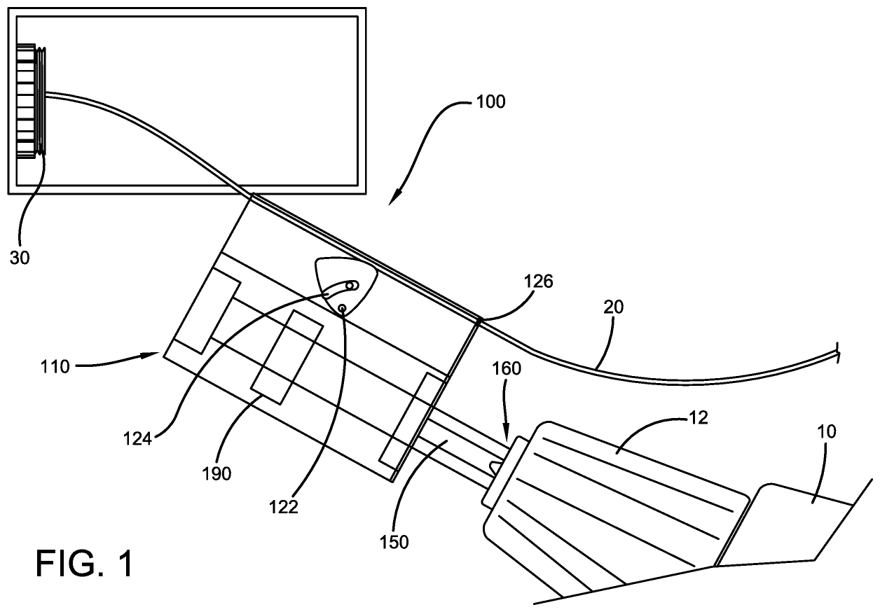

Referring initially to the drawings, FIG. 1 illustrates a side view of one potential embodiment of a fish tape drilling attachment device of the present invention wherein the housing is shown in a cross-sectional view and the device is being used to fish a fish tape through a conduit in accordance with the disclosed architecture. The device 100 is primarily comprised of a housing 110, further comprised of at least one bearing 172,174, at least one shaft 150, at least one cam 122, and at least one cam lever 124. The housing 110 and all components are preferably manufactured from a durable metal such as, but not limited to, stainless steel or aluminum or a rigid plastic such as, but not limited to: acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In the preferred embodiment, the housing 110 is generally cylindrical in shape and is comprised of a front wall 130, a side wall 120, and a rear wall 140. However, in differing embodiments the housing 110 may be any shape known in the art such as, but not limited to, square, circular, rectangular, polygonal, etc.

The rear wall 140 is comprised of at least one opening 142 that allows at least one shaft 150 to reside within an interior space 180 of the housing. The shaft 150 is further comprised of a first end 160 and a second end 170. The first end 160 is preferably a standard quick-connect shaft that allows the device 100 to be attached to any power drill 10 known in the art. At least one first bearing 172 attaches to or contacts the second end 170 near the rear wall 140 within the interior space 180. In the preferred embodiment, the bearing 172 is a ball bearing that ensures alignment of the shaft 150 within the opening 142 and interior space 180 during use. At least one second bearing 174 attaches to or contacts the second end 170 near the front wall 130 within the interior space 180. In the preferred embodiment, the bearing 172 is a thrust ball bearing that allows load from the shaft 150 to be applied and rotation to continue.

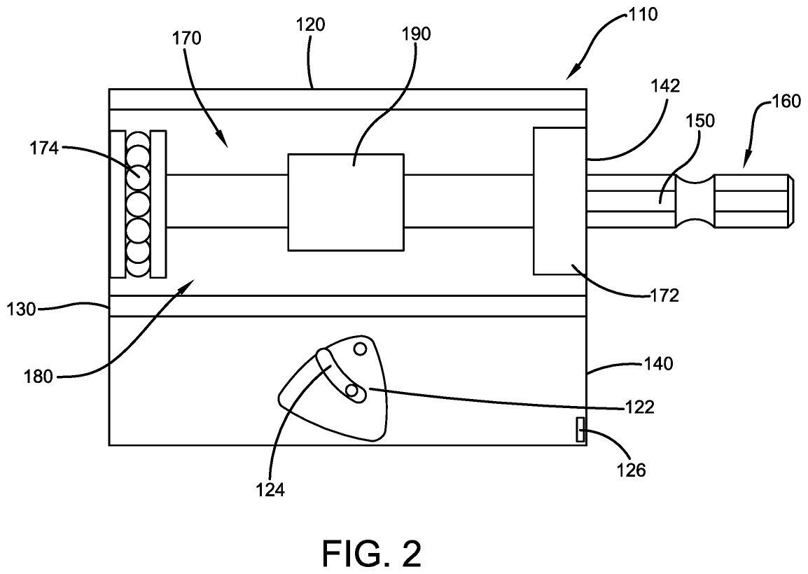

The housing 110 is further comprised of at least one cam 122 located within the housing 110. The position of the cam 122 within the housing can be adjusted via at least one cam lever 124. Fish tape 20 can be fed through an opening 126 of the housing 110 that extends from the front wall 130 to the rear wall 140. Once fed through the opening 126 (which acts as a guide), the cam 122 contacts the fish tape 20 within the housing 110, as seen in FIG. 2.

After the shaft 150 is attached to a drill 10 via the drill chuck 12, rotation of the chuck 12 will cause the shaft 150 to spin. The bearings 172,174 allow the shaft 150 to spin freely within the interior space 180, such that the hammer action of the drill 10 causes the fish tape 20 to act like a spring to slowly move the fish tape 20 through a piece of conduit 30.

In one embodiment, the device 100 may be comprised of an alternating hammer section 190 located within the housing 110. Preferably, the hammering section 190 is located between the first bearing 172 and the second bearing 174. The hammering section 190 provides a hammering motion to the fish tape 20 as it travels through the opening 126 to further facilitate the movement of the tape 20 through the conduit 30.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fish tape drilling attachment device” and “device” are interchangeable and refer to the fish tape drilling attachment device 100 of the present invention.

Notwithstanding the foregoing, the fish tape drilling attachment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fish tape drilling attachment device 100 as shown in the FIGS. are for illustrative purposes only, and that many other sizes and shapes of the fish tape drilling attachment device 100 are well within the scope of the present disclosure. Although the dimensions of the fish tape drilling attachment device 100 are important design parameters for user convenience, the fish tape drilling attachment device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fish tape drilling attachment device comprising:
a housing;
a cam;
a cam lever;
a shaft;
a first bearing; and
a second bearing.

2. The fish tape drilling attachment device of claim 1, wherein the cam is positioned within the housing.

3. The fish tape drilling attachment device of claim 2, wherein the housing is comprised of an opening.

4. The fish tape drilling attachment device of claim 3, wherein the opening acts as a guide for a fish tape.

5. The fish tape drilling attachment device of claim 4, wherein the cam is positioned in the opening.

6. A fish tape drilling attachment device comprising:
a housing comprised of a side wall, a front wall, and a rear wall that form an interior space;
an opening that extends from the front wall to the rear wall;
a cam;
a cam lever;
a shaft;
a first bearing; and
a second bearing.

7. The fish tape drilling attachment device of claim 6, wherein a first end of the shaft is comprised of a quick-connect shaft.

8. The fish tape drilling attachment device of claim 6, wherein a second end of the shaft is positioned within the housing.

9. The fish tape drilling attachment device of claim 6, wherein the first bearing and the second bearing contact the second end of the shaft.

10. A fish tape drilling attachment device comprising:
a housing comprised of a side wall, a front wall, and a rear wall that form an interior space, and an opening that extends from the front wall to the rear wall;
a cam positioned within the housing;
a cam lever that adjusts a position of the cam;
a shaft;
a first bearing; and
a second bearing.

11. The fish tape drilling attachment device of claim 10, wherein the first bearing aligns a second end of the shaft within the interior space.

12. The fish tape drilling attachment device of claim 10, wherein the first bearing is a ball bearing.

13. The fish tape drilling attachment device of claim 10, wherein the second bearing is a thrust ball bearing.

14. The fish tape drilling attachment device of claim 10, wherein the first bearing and the second bearing allow the shaft to spin.

15. The fish tape drilling attachment device of claim 10 further comprising a hammering section.

16. The fish tape drilling attachment device of claim 1, wherein the hammering section is located between the first bearing and the second bearing within the housing.

17. The fish tape drilling attachment device of claim 16, wherein the hammering section provides a hammering motion.

18. The fish tape drilling attachment device of claim 10, wherein the second ball bearing is positioned on the front wall within the interior space.

19. The fish tape drilling attachment device of claim 10, wherein the first ball bearing is positioned on the rear wall within the interior space.

20. The fish tape drilling attachment device of claim 10, wherein the housing is a cylindrical housing.
